(19) United States
(12) Patent Application Publication
(10) Pub. No.: US 2004/0128248 A1
(43) Pub. Date: Jul. 1, 2004

(54) Method for managing account, method for performing settling, method for managing lot, computer readable recording medium, account managing/settling system, and lot managing system

(75) Inventors: Mutsumi Fujihara, Kanagawa-Ken (JP); Etsuo Saito, Kenagawa-Ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/729,982

(22) Filed: Dec. 9, 2003

(30) Foreign Application Priority Data
Dec. 10, 2002 (JP) 2002-358697
Nov. 18, 2003 (JP) 2003-388249

(51) Int. Cl. G06F 17/60

(52) U.S. Cl. 705/42

(57) ABSTRACT

The present invention is to make it possible to perform update processing and retrieval processing independently from each other and in parallel to each other. Even when a processing is interrupted due to occurrence of a system failure during update processing or the like, retrieval processing to the remaining date can be performed correctly, and such data can be judged to be data put in an interrupted state during the update processing. At a time of a new account registration, trust records showing preset unit amounts are registered in the new account by the number corresponding to the balance in the account. The trust record comprises a trust ID, a unit amount and an account number. At a time of money reception/payment in each account, a money reception/payment processing is conducted by additionally registering trust records of the number corresponding to a money reception amount or by performing retrieval/deletion of trust records of the number corresponding to a payment amount. At a time of settlement between account, a transfer processing between the accounts is performed by retrieving the trust records of the number corresponding to a settlement amount from the trust records having an account number of a transfer source and changing the account numbers of all the retrieved trust records to an account number of a transfer destination.

### CROSS-REFERENCE TO RELATED APPLICATIONS

This application is based upon and claims the benefit of priority from prior Japanese Patent Applications No. 2002-358697, filed on Dec. 10, 2002 and No. 2003-388249, filed on Nov. 18, 2003 in Japan, the entire contents of which are incorporated herein by reference.

### BACKGROUND OF THE INVENTION

1. Field of the Invention

The present invention relates to a method for managing a resource which can be divided and merged, especially a lot managing method for managing lot of materials/parts and an account managing/settling method for managing coins, namely trust account.

2. Related Art

In a conventional banking system, data regarding deposit accounts is represented in a form of an account record provided for each account. As shown in FIG. 11, for example, such an account record 1100 is constituted with an account number 1101, a deposit name 1102, an address 1103, a telephone number 1104, the balance 1105 and the like. That is, credit/currency such as deposit balance is conventionally reserved and managed as one numeral value attribute data piece in the account record. Further, transfer between accounts is performed by transferring money information between the accounts (for example, refer to Japanese Patent Laid-Open Pub. No.2001-243400).

Now, in the conventional managing method of a deposit account such as described above, when a transfer processing between accounts is performed, it is necessary to lock an account record of a transfer source and an account record of a transfer destination simultaneously and perform two operation of an operation for reducing the balance of the transfer source by a transfer amount and an operation for increasing the balance of the transfer destination by the transfer amount.

However, since it is difficult to perform the two operations just simultaneously, there is such a possibility that, after one of the operations has been performed, a system failure will occurs before the other operation, which results in situation where the other operation can not be performed. When such a situation occurs, the operation for transfer processing itself can not be completed but also the system falls in an unjust state such as an imbalance of some accounts. That is, since states of data under update processing includes a state where application of a retrieval processing can not be performed correctly, there is a problem that the retrieval processing can not be applied during the updating processing. Therefore, after the transfer/updating processings have been interrupted, as described above, it is also difficult to retrieve the remaining data to find out the fact of the interruption.

Such a problem that the retrieval processing and the updating processing can not be conducted independently from each other and in parallel to each other also occurs in a lot management of material or parts whose amount or number can be divided or merged regarding the same or one item.

### SUMMARY OF THE INVENTION

The present invention has been proposed for solving the problem in the conventional art described above and an object thereof is to provide an account managing method, an account settling method, an account managing system, a lot managing method and a lot managing system where an updating processing and a retrieval processing can be conducted independently from each other and in parallel to each other. Thereby, such an advantage can be obtained that, even when an operation has been interrupted due to a system failure or the like during an updating operation, a retrieval operation can correctly be performed to the remaining data and judgment can be made that the system is in a state where the updating operation has been interrupted.

A method of managing an account utilizing a computer according to the first aspect of the present invention includes: registering records of preset unit amount to each account by the number corresponding to the balance in the account.

A method of performing settling between amounts utilizing a computer according to the second aspect of the present invention includes: registering records showing preset unit amounts to each account by the number corresponding to the balance in the account; retrieving, from records showing unit amounts registered in an account of a transfer source, records of the number corresponding to an amount to be settled when settlement between accounts is required; and changing all the retrieved records to records in an account of a transfer destination.

A computer-readable medium according to the third aspect of the present invention containing an account managing program for managing an account utilizing a computer, the program including instructions for: registering records showing preset unit amounts to each account by the number corresponding to the balance in the account.

A computer-readable medium according to the fourth aspect of the present invention containing an account settling program for settling an account utilizing a computer, the program including instructions for: registering records showing preset unit amounts to each account by the number corresponding to the balance in the account and retrieving, from records showing unit amounts registered in an account of a transfer source, records of the number corresponding to an amount to be settled when settlement between accounts is required and changing all the retrieved records to records in an account of a transfer destination.

A lot managing method for managing the locations/possessions of articles in a dividable lot utilizing a computer according to the fifth aspect of the present invention includes registering a preset unit quantity of records by the number corresponding to the generated quantity when the articles are generated as a subject to be managed in one location/possession.

An account managing/settling system according to the sixth aspect of the present invention includes an input/output control section, a money reception/payment processing section, a transfer processing section, a balance inquiry processing section, an account opening/canceling processing section, a trust record changing section, a trust record retrieving section, an account record changing section, an account record retrieving section, a trust record storing section, an account record storing section and a plurality of terminals, wherein

the input/output control section receives each of processing demands from the plurality of terminals to judge contents thereof, and transmit data attendant to the processing demand to either one of the money reception/payment processing section, the transfer processing section, the balance inquiry processing section, and the account opening/canceling processing section to request a processing;

the money reception/payment processing section instructs the trust record changing section to perform addition/deletion of trust records corresponding to the instructed amount from the input/output control section, the trust record changing section performs a processing for the instructed addition/deletion of trust records and an upper/lower exchanging processing accompanied by the same to the trust record stored in the trust record storing section and, when the processing is completed, notifies the money reception/payment processing section that the instructed change of the trust records has been completed, and the money reception/payment processing section notifies the input/output control section of the completion of the money reception/payment processing on the basis of the notification of the completion of the instructed trust record change, and the input/output control section notifies the completion of the processing to the terminal which generated the corresponding processing demand;

the transfer processing section transmits a transfer source account number, a transfer destination account number and a transfer amount sent from the input/output control section to the trust record changing section to instruct the trust record changing section to perform changing of the account numbers of the trust records, the trust record changing section performs the instructed changing processing of the account numbers and a necessary lower/upper exchanging processing to the trust records stored in the trust record storing section and, when the processing is completed, notifies a completion of the processing to the transfer processing section, the transfer processing section transmits a completion notification of the processing to the input/output control section, and the input/output control section transmits the completion notification to the terminal which generated the transfer processing demand;

the balance inquiry processing section transmits the account number to the trust record retrieving section to instruct the trust record retrieving section to perform accumulation of the balance in the account, the trust record retrieving section retrieves trust records having the instructed account number from the trust record storing section to check trust IDs of the trust records having the instructed account number and sum unit amounts of the trust records which have been determined to be accumulable as the balance and notifies the balance to the balance inquiry processing section, the balance inquiry processing section transmits the balance to the input/output control section, and the input/output control section returns the balance to the terminal which generated the inquiry demand;

on receipt of an account opening demand from the input/output control section, the account opening/canceling processing section instructs the account record changing section and the trust record changing section to perform registration of account records and trust records of a designated account number, the account record changing section and the trust record changing section produce the instructed records to register the records in the account record storing section and the trust record storing section, respectively, the account record storing section and the trust record storing section return processing completion notifications back to the account opening/canceling processing section, the account opening/canceling processing section notifies completion of the account opening processing to the input/output control section on receipt of both the completion notifications, the input/output control section receives the completion notification of the account opening processing to transmits a processing completion to the terminal which generated the opening demand; and

on receipt of an account canceling demand from the input/output control section, the account opening/canceling processing section instructs the account record changing section and the trust record changing section to perform deletion of the account records and the trust records having the designated account number, the account record changing section and the trust record changing section delete the designated records from the account record storing section and the trust record storing section, respectively, the account record storing section and the trust record storing section return processing completion notifications to the account opening/canceling processing section, the account opening/canceling processing section notifies completion of the account canceling processing to the input/output control section upon receipt of both the processing completion notifications, and the input/output control section transmits a processing completion to the terminal which generated the canceling demand upon receipt of the notification of the completion of the account canceling processing.

A lot managing system according to the seventh aspect of the present invention includes an input/output control section, a lot registration processing section, a lot update processing section, a lot deletion processing section, a lot retrieval processing section, a unit lot record changing section, a unit lot record retrieving section, a unit lot record storing section, and a plurality of terminals, wherein

the input/output control section receives each of processing requests generated from the plurality of terminals to judge contents thereof and transmit data attendant to the processing demand to either one of the lot registration processing section, the lot update processing section and the lot retrieval processing section to request a processing;

the lot registration processing section has a designated article name and initial history and instructs the unit lot record changing section to perform addition of unit lot records of kinds and quantity corresponding to a designated quantity, the unit lot record changing section performs the instructed addition of the unit lot records to the unit lot record storing section, upon completion of the addition, the unit lot record changing section notifies the completion to the lot registration processing section, the lot registration processing section transmits the completion of the lot registration processing to input/output control section, and the input/output control section notifies the completion of the processing to the terminal which generated the lot registration processing demand;

the lot update processing section instructs the unit lot record retrieving section to perform retrieval of unit lot records having a designated article name/history, the unit lot retrieving section retrieves coincident unit lot records from the unit lot records in the unit lot record storing section to return the same back to the lot update processing section, the lot update processing section instructs the unit lot record changing section so as to change histories of unit lot records of the designated quantity from the retrieved unit lot records, the unit lot record changing section performs a record division processing, as needed, and change histories of unit lot records corresponding to the designated quantity to notify completion of a history changing processing to the lot update processing section, the lot update processing section transmits completion of the lot update processing to the input/output control section, and the input/output control section notifies completion of the processing to the terminal which generated the lot update processing demand;

the lot deletion processing section instructs the unit lot retrieving section to perform retrieval of unit lot records having a designated article name/history, the unit lot record retrieving section retrieves coincident unit lot records from the unit lot records in the unit lot record storing section to return the same back to the lot deletion processing section, the lot deletion processing section instructs the unit lot record changing section to perform deletion of the retrieved unit lot records, the unit lot record changing section deletes the instructed unit lot records from the unit lot record storing section to notify deletion completion to the lot deletion processing section, the lot deletion processing section transmits a lot deletion processing completion to the input/output control section, the input/output control section notifies the completion of the processing to the terminal which generated the lot deletion processing demand; and

the lot retrieval processing section instructs the unit lot record retrieving section to perform retrieval of unit lot records having a designated article name/history, the unit lot record retrieving section retrieves coincident unit lot records from the unit lot record storing section to accumulate unit quantities of retrieved unit lot records and return the same back to the lot retrieval processing section, the lot retrieval processing section returns the accumulation result of the unit quantities back to the input/output control section as the quantity of the designated lot, and the input/output returns the accumulation result to the terminal which generated the lot retrieval demand.

According to the present invention, update and retrieval processings can be performed independently from each other and in parallel to each other.

### BRIEF DESCRIPTION OF THE DRAWINGS

FIG. 1 is a flowchart showing an outline of an account managing/settling method according to a first embodiment to which the present invention has been applied;

FIG. 2 is a data structure diagram showing a data structure of a trust record used in the account managing/settling method according to the first embodiment;

FIG. 3 is an explanatory diagram showing one example of specific trust records registered by the account managing/settling method according to the first embodiment;

FIG. 4 is an explanatory diagram showing one example of a state where a transfer processing has been performed on the trust records shown in FIG. 3;

FIG. 5 is a flowchart showing an exchanging processing which is conducted in the account managing/settling method according to the first embodiment, as needed;

FIG. 6 is an explanatory diagram showing one example of a state where a lower exchanging processing has been conducted on the trust records shown in FIG. 4;

FIG. 7 is an explanatory diagram showing one example of a state where a transfer processing has been conducted on the trust records shown in FIG. 6;

FIG. 8 is an explanatory diagram showing one example of a state where an upper exchange processing has been conducted on the trust records shown in FIG. 7;

FIG. 9 is a flowchart showing a balance computing processing which is conducted in parallel with the exchanging processing shown in FIG. 5;

FIG. 10 is an explanatory diagram showing one example of a state where rearrangement has been conducted on the trust records shown in FIG. 8 and re-attaching of trust IDs has been made;

FIG. 11 is a data structure diagram showing one example of a data structure of an account record used in a conventional deposit account managing method;

FIG. 12 is a block diagram showing a constitution of an account managing system for performing a method of the first embodiment;

FIG. 13 is a diagram showing a constitution of a unit lot record in a lot managing method according to a second embodiment of the present invention;

FIG. 14 is a flowchart showing a processing procedure of the lot managing method according to the second embodiment;

FIG. 15 is a diagram showing a unit lot record representing that 100 parts A belong to reception;

FIG. 16 is a flowchart showing a procedure of a record dividing processing according to the second embodiment;

FIG. 17 is a diagram showing that lot records representing 60 parts of a divided unit lot which have been transferred to a first line;

FIG. 18 is a diagram showing unit lot records representing that 30 parts A have been transferred to a second line;

FIG. 19 is a diagram showing unit lot records obtained after 20 parts A in the first line have been assembled in the product 1#101 and 20 parts A therein have been assembled in the product 1#102;

FIG. 20 is a diagram showing unit lot records obtained after 20 parts A in the second line have been assembled in the product 1#201 and 10 parts A therein have been assembled in the product 2#202;

FIG. 21 is a flowchart showing a checking procedure at a time of quantity summing of the retrieval result according to the method of the second embodiment;

FIG. 22 is a diagram showing a record on which an inherent ID has been written at the time of reception;

FIG. 23 is a diagram showing unit lot records on which an inherent ID has been written in the reception step; and

FIG. 24 is a block diagram showing a constitution of a system for performing the method of the second embodiment.

### DESCRIPTION OF THE EMBODIMENTS

Embodiments of the present invention will be specifically explained below with reference to the drawings. Incidentally, the embodiments described herein do not apply any limitation to the present invention but they only exemplifies some aspects of the present invention.

The present invention can typically be realized by controlling a computer with a software. A software used in this case is for realizing an operation and an advantage of the present invention by utilizing a hardware of the computer physically, and a suitable conventional technique is applied to a portion to which the conventional technique is applicable. Further, a specific kind or constitution of a hardware or a software for realizing the present invention and/or a range which is processed by the software can be changed, for example, a program for realizing the present invention is one aspect of the present invention.

(First Embodiment)

(1. Outline of an Account Managing/Settling Method)

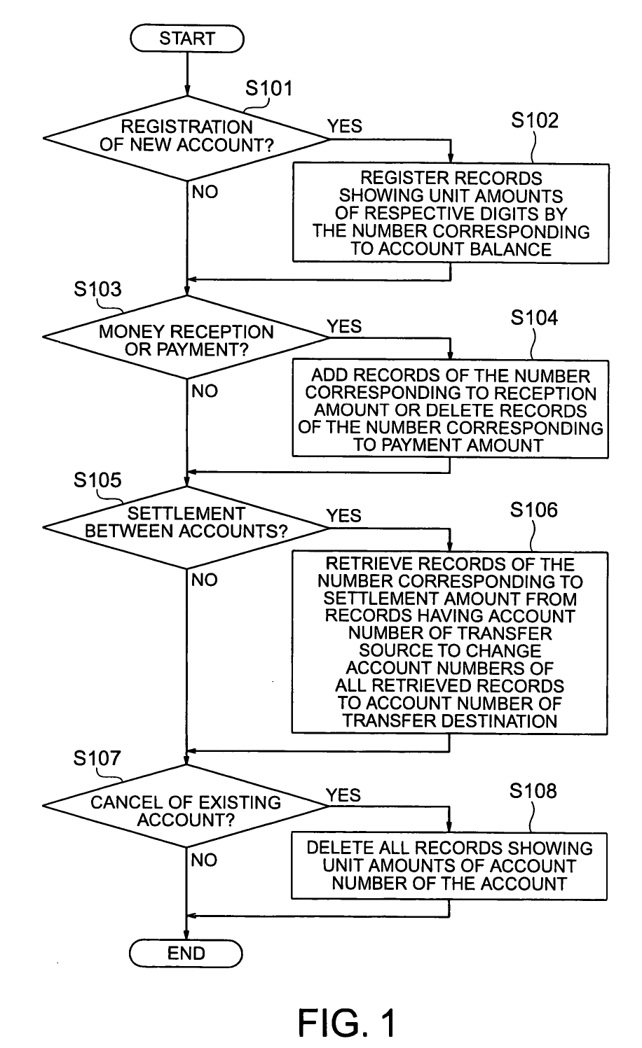

FIG. 1 is a flowchart showing an outline of a method for performing account management and settlement to a plurality of deposit accounts in a financial institution such a bank according to a first embodiment of the present invention. As shown in FIG. 1, in this embodiment, trust records of a preset unit amount is registered at the time of registration of a new account (YES in Step S101) by the number corresponding to the balance of the new account (S102).

That is, in the embodiment, an account record is not provided for each account in the conventional manner, but “trust records” (200) constituted with “trust ID” (201), “unit amount” (202), and “account number” (203) are registered by the number corresponding to the balance of each account. Here, the “trust ID” is set for guaranteeing and identifying a uniqueness of each record such as a bill number. The “unit amount” is an amount having the minimum number of each digit in an amount expressed by decimal notation as a unit such that the numerical value of the head is “1” and numerical values subsequent thereto are “0” such as 1,000,000 yen, 100,000 yen, 10,000 yen, 1,000 yen, 100 yen or the like. The “account number” is a number for guaranteeing and identifying uniqueness of each account.

For example, in case that a deposit balance is 123,000 yen in an account attached with an account number “A”, a deposit balance is 31,200 yen in an account attached with an account number “B”, and a deposit balance is 213,000 yen in an account attached with an account number “C”, 18 trust records are registered so as to correspond to these accounts, as shown in FIG. 3. That is, a state that, of the sum balance of 367,200 yen, 123,000 yen is held in the account “A”, 31,200 yen is held in the account “B” and 213,000 yen is held in the account “C” is represented in FIG. 3. In this case, the trust records have been registered in the order of higher unit amounts, the same unit amounts have been registered in an ascending order (in the order of A, B and C) of the account numbers, and attachment of trust IDs continuous numbers “1” to “18” is made.

At a time of money reception or payment to/from each account (YES in Step S103), reception processing is made by additionally registering the number of trust records corresponding to a reception amount as the trust record having the account number of the account and payment processing is made by retrieving the number of trust records corresponding to the payment amount of the trust records having the account number of the account to delete all trust records retrieved (S104).

In the example shown in FIG. 3, for example, when payment of 13,000 yen is made from the account “C”, one trust record (trust ID=9) of a unit amount “10,000 yen” and three trust records (trust ID=14, 15 and 16) of a unit amount “1,000 yen” are retrieved from the trust records with the account number “C” of the account so that the trust records retrieved can be deleted.

Further, in case that settlement between accounts is required (YES in Step S105), a transfer processing between the accounts is performed by retrieving the trust records corresponding to the number of the settlement amount from the trust records having the account number of the account of the transfer source to change all the trust records retrieved to the trust records having the account number of the account of the transfer destination (S106).

In the example shown in FIG. 3, for example, transfer processing of 13,000 yen is conducted from the account “C” to the account “A”, the transfer can be conducted by retrieving one trust record (trust ID=9) of a unit amount “10,000 yen” and three trust records (trust ID=14, 15 and 16) of a unit amount “1,000 yen” from the trust records having the account number “C” of the account of the transfer source to change the account number “C” of these trust records to the account number “A”.

Incidentally, in the transferring processing between accounts such as described above, since a plurality of trust records are handled, it is necessary to conduct a plurality of updating operations such as changing account number fields in the respective trust records. However, each trust record has one of the account numbers of the transfer source and the transfer destination before and after execution of each operation, the total balance in these accounts is not changed and the system is prevented from falling in an unjust state such as mismatch in balance.

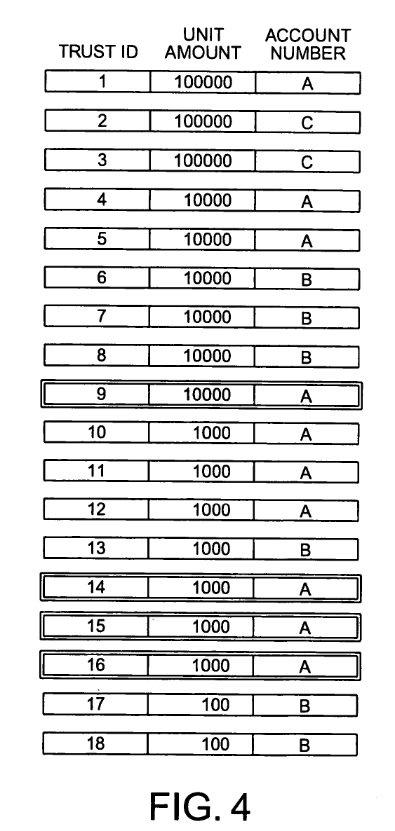

The trust records after the transfer processing has been completed in the above example shown in FIG. 3, are changed to their states shown in FIG. 4. In this case, the balance “136,000 yen” in the account “A” after transfer can be obtained by retrieving all the trust records having the account number “A” to sum the unit amounts of the trust records (trust ID=1, 4, 5, 9, 10, 11, 12, 14, 15 and 16). Incidentally, in FIG. 4, respective trust records changed or added are shown in an enhancing manner by a double frame. In the figures described hereinafter, also, trust records changed/added are shown with such a double frame.

Further, when an existing account is canceled (YES in Step S107), a canceling processing is conducted by retrieving the trust records of unit amounts having an account number of the account to delete all the trust records retrieved (S108).

(2. Exchanging Processing)

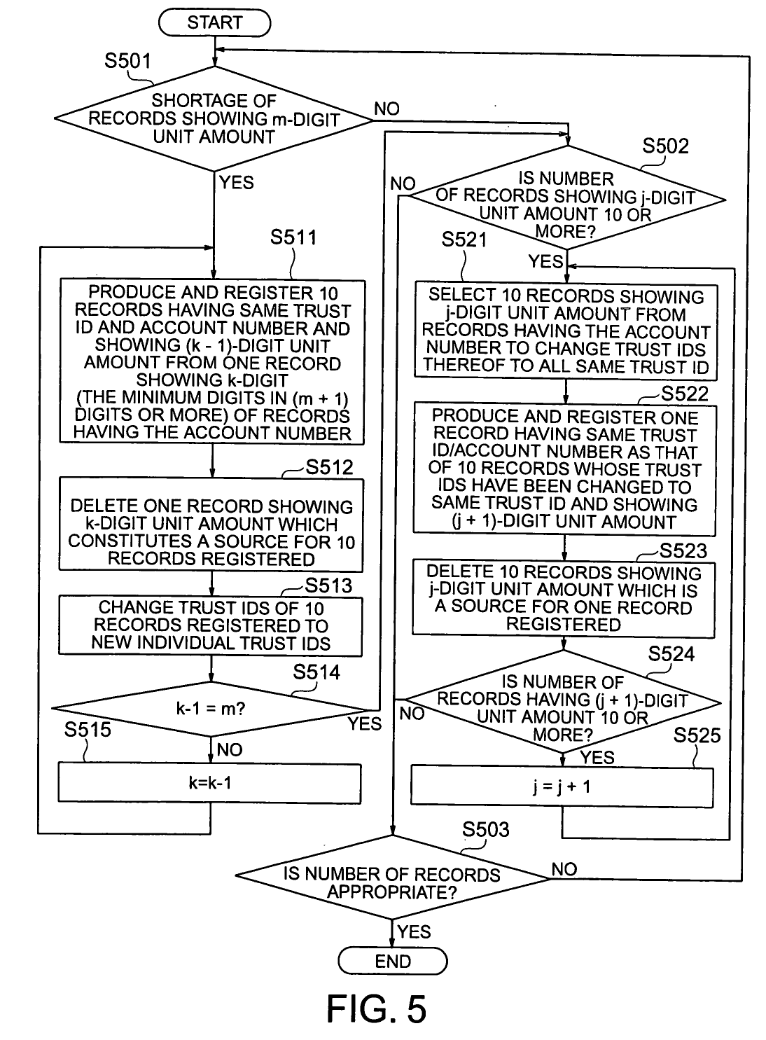

FIG. 5 is a flowchart showing an exchanging processing performed in the amount managing and settling method shown in FIG. 1, as needed. Before and after reception/payment processing or transfer processing, or at a time of another processing, when the number of trust records of one unit amount is short (YES in Step S501) or on the contrary when the number of trust records of one unit mount is too many (YES in Step S502), a lower exchanging processing or an upper exchanging processing is conducted in response to excess or shortage of the trust records of the unit amount according to the procedure shown in FIG. 5 until the number of the trust records of the unit amount reaches an appropriate number (S511 to S515 or S521 to S525). When the number of the trust records reaches the appropriate number (YES in Step S503), the exchanging processing is terminated. The details of the lower exchanging processing and the upper exchanging processing will be sequentially explained below.

(2-1: Lower Exchanging Processing)

In a money reception/payment processing or a transfer processing to a designated account, when the trust records of an m-digit (m is an integer) unit amount required for processing is short in trust records having the account number and showing unit amounts in respective digits expressed by decimal notation (YES in Step S501), a lower exchanging processing to a unit amount in a lower digit is performed in a procedure shown in FIG. 5 (S511 to S515). The lower exchanging processing is conducted in the following manner.

First, from one trust record showing a unit amount with k digits which is a minimum-digit unit amount of (m+1)- or more-digit unit amounts in trust records having the account number, 10 trust records showing a (k−1)-digit unit amount having the same trust ID and the same account number is first produced and registered (a lower unit record producing step: S511). Then, the one record showing the unit amount with k digits which is the source for the ten trust records showing the (k−1)-digit unit amount registered is deleted (an upper unit record deleting step: S512).

Then, trust IDs of the 10 trust records showing the registered (k−1)-digit unit amount are changed to new individual trust IDs (an individual ID changing step: S513). Further, when the (k−1) digit does not correspond to m digit (NO in Step S514), Steps S511 to S514 are repeated using the previous (k−1) as a new k (S515) until the (k−1) digit is coincident with the m digit.

In the example shown in FIG. 4, for example, when transfer of “8,800 yen” from the account “C” to the account “B” is performed, the trust records showing a quadruple-digit unit amount “1,000 yen” and the trust records showing a triple-digit unit amount “100 yen” are retrieved from the trust records having the account number “C” of the account which is a transfer source. However, since no trust record with the quadruple-digit unit amount “1,000 yen” in the trust records having the account number “C”, the trust records showing the minimum-digit unit amount of five- or more-digit unit amounts are retrieved.

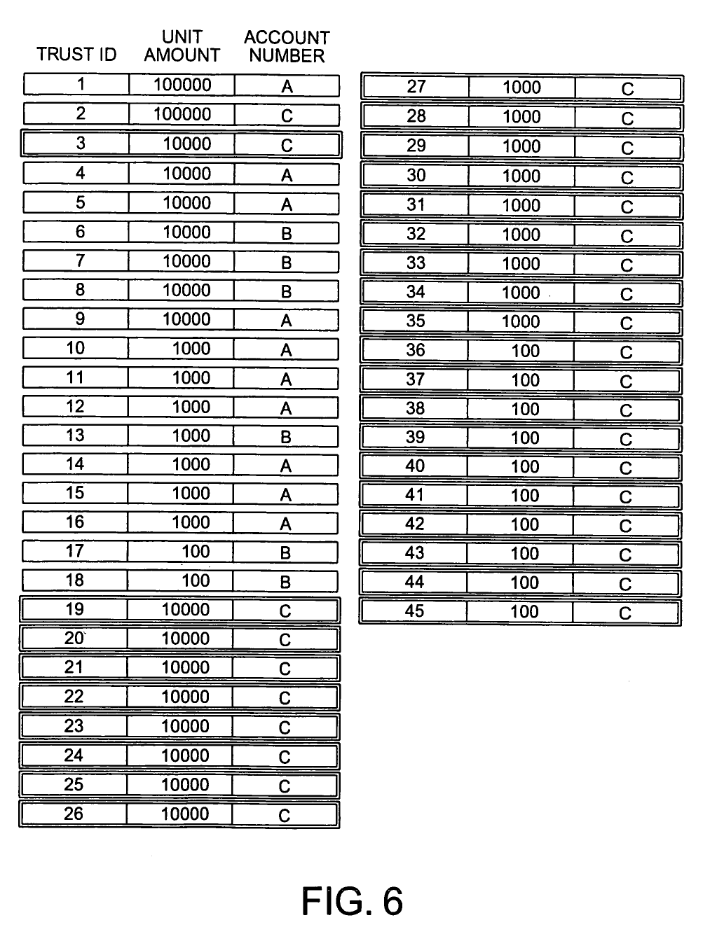

In this case, two trust records (trust ID=2 and 3) of a six-digit unit amount “100,000 yen” are retrieved as the trust record showing the minimum-digit unit amount of at least five digits having the account number “C”. Therefore, a lower exchanging processing is performed on one trust record (for example, the trust ID=3) of the trust records to produce 8 trust records showing the quadruple-digit unit amount “1,000 yen” and the triple-digit unit amount “100 yen” which are required for the transfer processing. At this time, the trust records after completion of the lower exchanging processing becomes a state shown in FIG. 6. Further, the processing procedure is as follows.

Ten trust records showing the five-digit unit amount “10,000 yen” having the same trust ID “3” and account number “C” as those of one trust record (trust ID=3) of the six-digit unit amount “100,000 yen” which is the source are produced and registered. At a time when the registered has been completed, the trust record (trust ID=3) of the six-digit unit amount “100,000 yen” which is the source is deleted. Then, the respective trust IDs “3” of 10 trust records showing the produced trust ID “3” and unit amount “10,000 yen” are changed to new unique IDs such as “3”, and “19” to “27”, for example.

Since the digit number “5” of the unit amount “10,000 yen” of 10 trust records (trust ID=3, and 19 to 27) obtained by division in this manner are different from the necessary digit numbers “4” and “3”, one trust record (for example, the trust ID=27) is selected from the 10 trust records, and a producing operation of 10 trust records from the one trust record, a deleting operation of one trust record which is a source for the 10 trust records and an ID changing operation of 10 trust records are performed like the above. As a result, 10 trust records having trust IDs “27” to “36”, respectively, and showing the unit amount “1,000 yen” can be obtained.

Further, for example, 10 trust records having trust IDs “36” to “45”, respectively, and showing the unit amount “100 yen” can be obtained by selecting one trust record (for example, trust ID=36) and performing a producing operation of 10 trust records from the one record, a deleting operation of the one trust record which is the source and an ID changing operation of the ten trust records like the above.

Regarding the account “C”, the nine trust records (trust ID=3 and 19 to 26) showing the five-digit unit amount “10,000 yen”, the 9 trust records (trust ID=27 to 35) showing the quadruple-digit unit amount “1,000 yen”, and the ten trust records (trust ID=36 to 45) showing the triple-digit unit amount “100 yen” can finally be obtained from the trust record (trust ID=3) of the six-digit unit amount “100,000 yen” according to the lower exchanging process comprising three steps as described above.

In the example shown in FIG. 6, when all the trust records having the account number “C” are retrieved and the unit amounts of the trust records (trust ID=2, 3, and 19 to 45) are summed, the same balance “200,000 yen” as that before the lower exchanging processing can be obtained as the balance in the account “C”.

The procedure for transfer can be completed by selecting 8 trust records (for example, trust ID=27 to 34) showing the unit amount “1,000 yen” of four digits and 8 trust records (for example, trust ID=36 to 43) showing the unit amount “100 yen” of three digits which are required for a transfer processing from the trust records of the account “C” obtained newly in the above manner, and changing their account numbers from “C” to “B”. That is, the transfer processing of “8,800 yen” from the account “C” to the account “B” is performed.

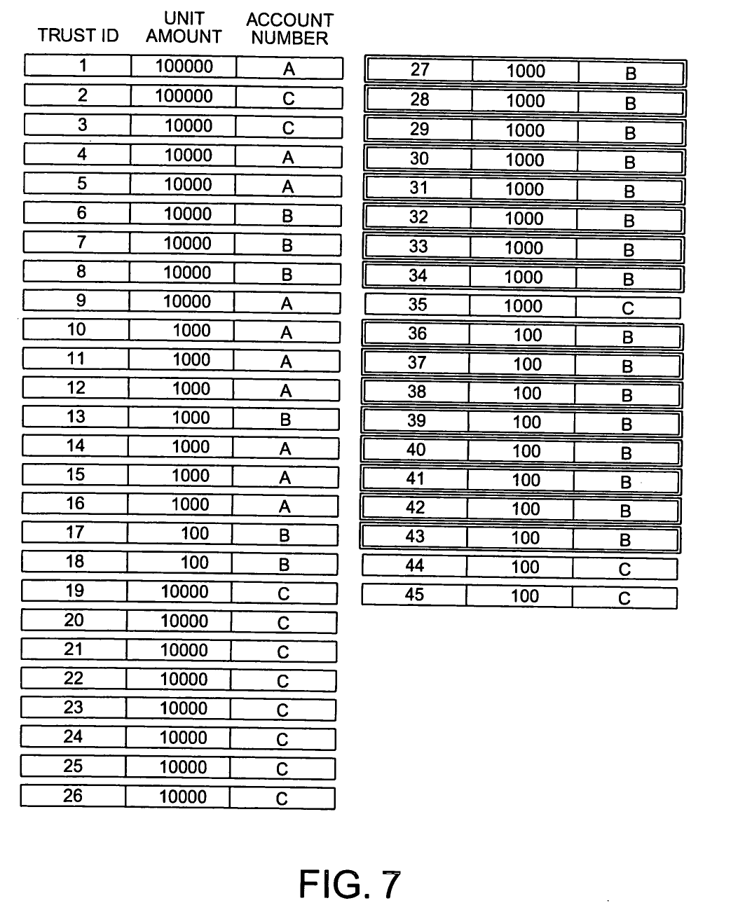

The trust records after completion of the transfer processing in the example shown in FIG. 6 are changed to a state shown in FIG. 7. In this case, when all the trust records having the account number “B” are retrieved and the unit amounts of the trust records (trust ID=6 to 8, 13, 17, 18, 27 to 34 and 36 to 43) are summed, the balance “40,000 yen” coincident with the summed amount obtained by adding the transfer amount “8,800 yen” to the balance “31,200 yen” before the transfer processing can be obtained as the balance in the account “B”.

(2-2: Upper Exchanging Processing)

After a money reception/payment processing or a transfer processing to a designated account has been performed and so on, when the number of trust records showing j-digit (j is an integer) unit amounts in the trust records having the account number and showing the unit amounts of respective digits expressed by decimal notation is 10 or more (YES in Step S502), an upper exchanging processing to the unit amount of the upper digit is performed (S521 to S525). The upper exchanging processing is performed in the following manner.

Ten trust records showing the unit amount of j digit are selected from the trust records having the account number, and all trust IDs of the selected trust records are changed to the same trust ID (same ID changing step: S521). Next, one trust record having the (j+1)-digit unit amount and showing the same ID and account number as those of the 10 trust records showing the j-digit unit amount, whose trust ID have been changed to the same trust ID is produced and registered (an upper unit record producing step: S522).

Then, the 10 records showing the j-digit unit amount which are the source for the registered one trust record showing the (j+1)-digit unit amount are deleted (a lower unit record deleting step: S523). Further, when there are 10 or more trust records showing the (j+1)-digit unit amount (YES in Step S524), the Steps S521 to S524 are repeated using the previous (j+1) as a new j (S525).

In the example shown in FIG. 7, for example, the total 22 trust records including 10 trust records (trust ID=17, 18 and 36 to 43) showing the unit amount “100 yen”, and 9 trust records (trust ID=13 and 27 to 43) showing the unit amount “1,000 yen” are included in the trust records of the account “B”. These trust records are maintained as they are, and they can be used, when a transfer demand from the account “B” is received. However, when transfers to the account “B” are continued, there occurs a problem that many trust records with small unit amounts collect in the account “B”, so that the number of the whole records increases.

In the embodiment, the number of the records is reduced by exchanging 10 trust records showing the triple-digit unit amount “100 yen” in the trust records in the account “B” to one trust record showing the quadruple-digit unit amount “1,000 yen” by the above upper exchanging step. The content of a processing performed at this time is as follows:

All trust IDs of 10 trust records (trust ID=17, 18 and 36 to 43) showing the triple-digit unit amount “100 yen” are first changed to the same trust ID, for example, trust ID “17”. Next, one trust record having the same trust ID “17” as the trust ID and the same account number “B” and showing the quadruple-digit unit amount “1,000 yen” is produced and registered. At the time of completion of the registration, 10 trust records with the trust ID “17” showing the triple-digit unit amount “100 yen” which is a source are deleted.

As the result that the upper exchanging processing of the trust records from the triple-digit unit amount to the quadruple-digit unit amount has been conducted, 10 trust records (trust ID=13, 17, and 27 to 34) showing the unit amount “1,000 yen” are included in the trust records in the account “B”. Therefore, regarding these 10 trust records showing the quadruple-digit unit amount “1,000 yen”, their trust IDs all are changed to the same ID, for example, trust ID “13”, and exchanging to one trust record having the trust ID “13” and showing the five-digit unit amount “10,000 yen” is conducted.

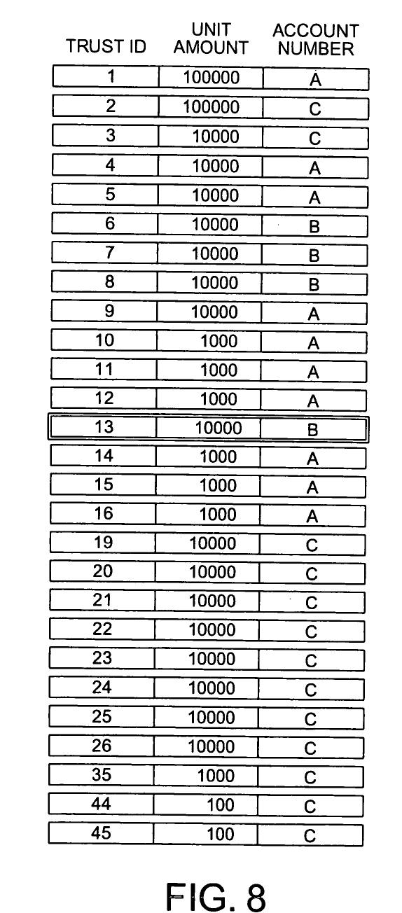

As the result that the upper exchanging processing comprising two stages of the step from the triple-digit unit amount to the quadruple-digit unit amount and the step from the quadruple-digit unit amount to the five-digit unit amount has been conducted in this manner, the trust records after the upper exchanging processing in the example shown in FIG. 7 are changed to a state shown in FIG. 8. In this case, when all the trust records having the account number “B” are retrieved and the unit amounts of the trust records (trust ID=6 to 8, and 13) are summed, the same balance “40,000 yen” as that before the upper exchanging process is performed can be obtained as the balance in the account “B”. In this case, also, only four trust records (trust ID=6 to 8, and 13) showing the five-digit unit amount “10,000 yen” are eventually included in the trust records in the account “B”. That is, by conducting the upper exchanging processing in the above manner, the number of the trust records in the account “B” can largely be decreased from 22 to 4.

(2-3: Balance Computing Processing Compatible with the Exchanging Processing)

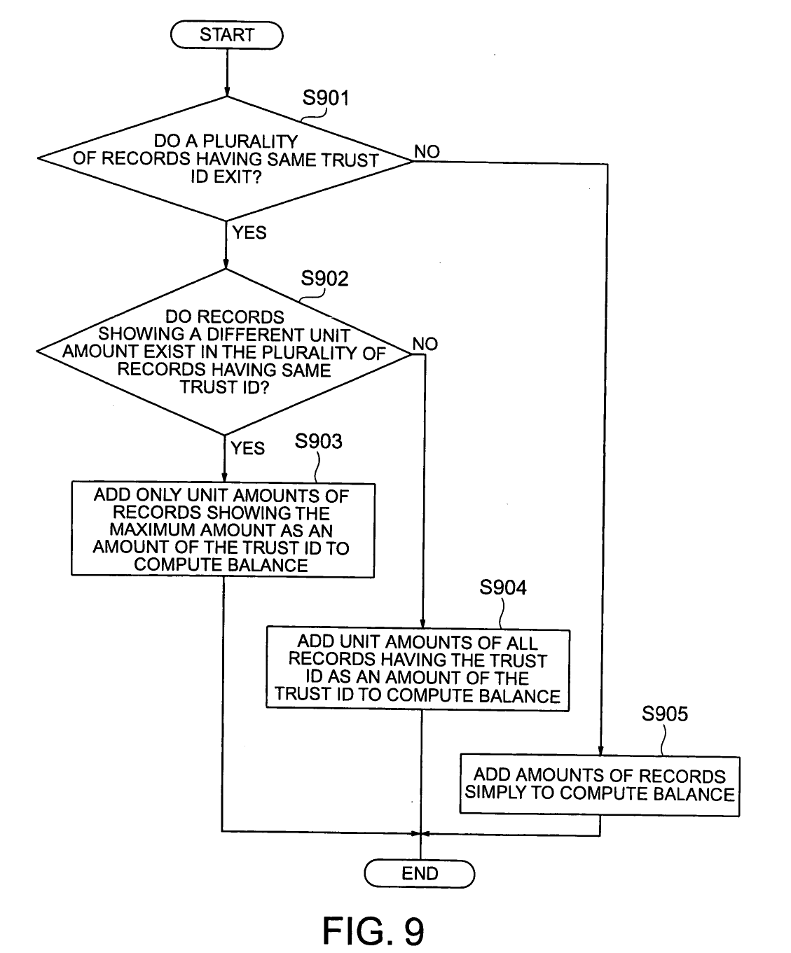

Incidentally, in this embodiment, when the balance in one account is computed in parallel execution of an exchanging processing such as the above, as shown in FIG. 9, judgment is made about whether or not there are a plurality of trust records having the same trust ID (S901), and a balance computing processing is conducted in response to the judgment result. That is, when there are a plurality of trust records having the same trust ID (YES in Step S901), it is recognized that the current processing is put in the course of the lower exchanging processing or the upper exchanging processing as described above, and judgment is further made about whether or not a trust record(s) with a different unit amount exists in the plurality of trust records (S902).

In case that the trust record with a different unit amount exists in the plurality of trust records having the same trust Id (YES in Step S902), only the unit amount of one trust record showing the highest unit amount of the trust records is added as the amount of the trust ID to obtain the balance (S903). On the contrary, in case that all the unit amounts of the plurality of trust records having the same trust ID are the same (NO in Step S902), the unit amounts of all the plurality of trust records having the same trust ID are added as the amount of the trust ID (S904). That is, the unit amount x the number of trust records is added as the amount of the trust ID. Further, when a plurality of trust records having the same trust ID does not exist (NO in Step S901), an ordinary balance computation where the amounts of trust records are simply added is performed (S905).

In the example shown in FIG. 4, for example, at the time when 10 trust records having the same trust ID “3” as that of one trust record (trust ID=3) showing the six-digit unit amount “100,000 yen” and the same account number “C”, and showing the five-digit unit amount “10,000 yen” have been produced and registered, two kinds of trust records showing the unit amount “100,000 yen” and the unit amount “10,000 yen” exist in the plurality of trust records having the trust ID “3”. In this case, therefore, only the unit amount “100,000 yen” of the highest amount as the unit amount of the trust ID “3” in the account “C” is added to obtain the balance. That is, the balance is obtained by adding the unit amount of the trust ID “2”, “100,000 yen”, and the unit amount of the highest amount of the trust ID “3”, “100,000 yen”, and the amount of the balance is “200,000 yen”.

On the other hand, in the example shown in FIG. 4, after 10 trust records having the trust ID “3” and the account number “C” and showing the five-digit unit amount “10,000 yen” have been produced and registered, when the trust records (trust ID=3) of the six-digit unit amount “100,000 yen” which is a source has been deleted, all the unit amounts of the trust records having the trust ID “3” become the same unit amount “10,000 yen”. In this case, therefore, the sum of all the unit amounts “10,000 yen” of the trust records having the trust ID “3” is added to obtain the balance. That is, in this case, the balance in the account “C” is obtained by adding “100,000 yen” which is the unit amount of the trust ID “2” and the unit amount “10,000 yen” x the number of records “10”, and its amount becomes “200,000 yen”.

In the example shown in FIG. 4, also, at a time when respective trust IDs of 10 trust records showing the five-digit unit amount “10,000 yen” and having the trust ID “3” and the account number “C” have been changed to new IDs “3”, and “19” to “27”, since a plurality of trust records having the same trust ID do not exist regarding the account “C”, the amounts of the trust records are added simply to obtain the balance. That is, the balance in the account “C” in this case is obtained by adding the unit amount “100,000 yen” indicated by the trust ID “2” and the respective unit amounts “10,000 yen” indicated by the trust IDs “3” and “19” to “27” simply and the amount becomes “200,000 yen”.

As becomes apparent from the above explanation, in the above-described lower exchanging processing, in case that the producing operation of 10 trust records, the deleting operation of the original one trust record and the ID changing operation of 10 trust records are sequentially performed, the balance can be computed accurately even at any time point in the course of the operations. In the upper exchanging processing, also, even in case that the ID changing operation of 10 trust records, the producing operation of one trust record and the deleting operation of the original 10 trust records are sequentially performed, the balance at any time point in the course of the operations can be obtained accurately by conducting a similar balance operation. In addition, even in the both exchanging processings, even when an interruption during either operation occurs, the interrupted state can be judged only from the contents of the trust records, so that the exchanging processing can be restarted easily and appropriately.

(3. Operation and Advantage of First Embodiment)

According to the account managing/settling method of the embodiment as described above, by registering trust records of preset unit amounts by the number corresponding to the balance in each account, the balance in the account becomes the sum of the amounts expressed by the trust records of the unit amounts registered in the account. By using trust records of unit amounts in this manner, settlement between accounts can be easily performed by the operation of retrieving the trust records of the number corresponding to the settling amount from the trust records of the unit amounts registered in the account of the transfer source and the operation of changing the account number of all the retrieved trust records to the account number of a transfer destination. As described in the balance computing operation compatible with the exchanging processing, a trust record retrieving section can compute an accurate balance by checking trust IDs of respective trust records in a procedure shown in FIG. 9 even in the middle that a trust record updating section is performing the exchanging processing according to the procedure shown in FIG. 5. Accordingly, the trust record retrieving section can always conduct a balance computation regardless of whether or not the trust records in a trust record storing section are put in the course of updating operation, a processing for a balance inquiry can be performed without delay. That is, the balance inquiry processing can be performed just in parallel with such an updating processing as a transfer. Further, even in case that an operation is interrupted due to a system failure or the like in the course of an operation for such a transfer processing between accounts, the registration destination of respective trust records of the unit amounts corresponding to the account of the transfer destination is changed to either one of the account of the transfer source and the transfer destination in response to a timing of the interruption, so that an unfair state such as a balance mismatching is prevented from occurring.

In this embodiment, further, by using amounts, utilizing minimum numbers of respective digits as units, as unit amounts, such as 1,000,000 yen (a seven-digit unit amount), 100,000 yen (a six-digit unit amount), 10,000 yen (a five-digit unit amount) and the like in decimal notation, an arbitrary amount can be expressed effectively according to a combination of the trust records of the unit amounts, which makes it easy to perform such a processing as an amount computation processing, a transfer processing and the like. Incidentally, in this embodiment, the decimal notation has been used as the unit amount, but another n base notation such as a binary notation and the like may be used. In this case, in case that the value of n is small, there is a possibility that the number of trust records is considerably increased. Therefore, it is usually preferable that the unit amounts expressed by the decimal notation, which is similar to a cash processing are used.

In particular, according to this embodiment, in case that there is not the required number of trust records showing the unit amount of designated digits in the trust records showing the unit amounts of the respective digits expressed by decimal notation, which are registered in the designated account, an exchanging operation from an upper unit amount to a lower unit amount can be performed by performing the lower exchanging processing that, from a trust record showing the unit amount higher than the unit amount of the designated digits, 10 trust records showing a unit amount lower than the unit amount by one digit are produced. Therefore, even when the trust records of the designated unit amount do not exist in the designated account, the trust records showing the unit amount of the required digits can be easily produced to conduct a settlement smoothly by exchanging a trust record showing a unit amount of a higher digit, which exists in the account at that time.

Further, in case that 10 or more trust records showing some-digit unit amount exist in trust records showing unit amounts of respective digits expressed with decimal notation, which have been registered in a designated account, exchanging from a lower unit amount to an upper unit amount can be conducted by producing, from 10 trust records showing a unit amount of some digits, one trust record showing a unit amount higher than that of those records by one digit. Therefore, in case that many trust records showing a unit amount of the same digit(s) exist in the designated account, the number of the whole trust records can be reduced as much as possible by exchanging these trust records to a trust record(s) showing a unit amount higher than that of the trust records appropriately.

That is, by reducing the number of trust records each time when the upper exchanging processing becomes applicable, the number of the total records can be kept in a state of (number of account numbers)×(number of kinds of unit amounts)×(base number of unit amount−1). Incidentally, the number of account numbers means the number of accounts which have been registered simultaneously in actual. On the other hand, since the number of kinds of unit amounts means the maximum digits of the balance in each account and the base number of the unit amount means n in the above n-base notation, the two parameters are fixed in advance. For example, in case that the balance of ten-digits (less than 10 billion) expressed by decimal notation is handled, 10×(10−1)=10×9=90. However, since a case that 90 records are required means only an account where all ten digits of its balance are 9, namely, an account showing the balance of 9,999,999,999, the number of records required for expressing the balance of each account is considerably smaller. Further, the number of account numbers means the number of accounts opened in actual, which is considerably smaller than the number of different values which can be expressed as account numbers.

Accordingly, since the number of trust records required in the account managing system of this embodiment is included in the number proportional to the number of accounts opened in actual, a storing capacity corresponding to the number of accounts to be handled can be estimated in advance. Thereby, such an advantage can be achieved that waste of storing capacity due to storage setting exceeding a required storing capacity can be prevented.

Incidentally, the present invention is not limited to the above-described processing procedure of the embodiment, and it can be implemented with a various aspects within the scope of the present invention. The processing procedure shown in FIG. 1, FIG. 5, FIG. 9 and the like is only one example, and a specific processing procedure can be change arbitrarily. For example, in the above-described embodiment, though the exchanging processing is performed before or after the money reception/payment processing or the transfer processing, a timing of performing the exchanging processing is not limited to this, but the exchanging processing can be performed at an arbitrary timing.

Incidentally, according to this embodiment, a deposit account in a financial institution is handled, but an account which can be handled by the present invention is not limited to this account and the present invention is also applicable to a settling account for a company or a resource other than the trust account, for example, an amount of use of computer or the like.

In the above-described embodiment, an amount utilizing, as a unit, the minimum number of each digit in an amount expressed by decimal notation, such as 1,000,000 yen, one 100,000 yen, 10,000 yen, 1,000 yen, 100 yen and the like is set to “a unit amount”, but the “unit amount” is not limited to only an amount utilizing the minimum number of each digit as the unit. For example, in the above-described embodiment, in addition to the respective unit amounts described above, it is thought that amounts other than the amount utilizing the minimum number, such as 500,000 yen, 50,000 yen, 5,000 yen, 500 yen and the like are used. That is, in this embodiment, the “unit amount” can be set arbitrarily for each digit.

In case that the above-described transfer processing has been conducted, the arrangement order of the account numbers for each unit amount is disturbed, as shown in FIG. 4. When not only such a transfer processing but also exchanging processing have been conducted, there occurs a possibility that, according to new production or deletion of a trust record(s), the arrangement order of the trust records corresponding to the trust IDs is changed to the production order of the trust records, as shown in FIG. 8, which causes a loss of the relationship between the arrangement order and the amount of a unit amount or causes a missing number, so that it becomes difficult to grasp the entire trust records on the basis of the trust IDs.

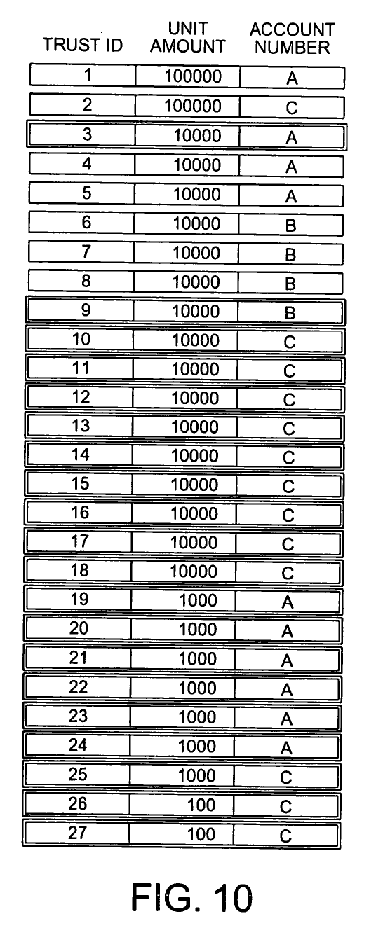

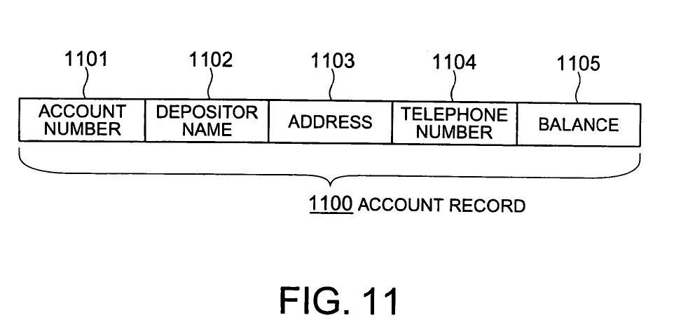

On the other hand, at an arbitrary timing, such as a time when transfer processing has been conducted one time or a time when transfer processing have been conducted plural times, trust records are rearranged in the higher order of unit amounts and trust records having the same unit amount are rearranged in the ascending order of the account numbers (in the order of A, B, C, . . . ), and their trusts IDs are reattached with continuous numbers in such an rearranged state so that it is made easy to grasp the whole trust records on the basis of the trust IDs. FIG. 10 shows a state after such rearrangement of trust records have been conducted to the trust records shown in FIG. 8 and reattachment of their trust IDs have been conducted.

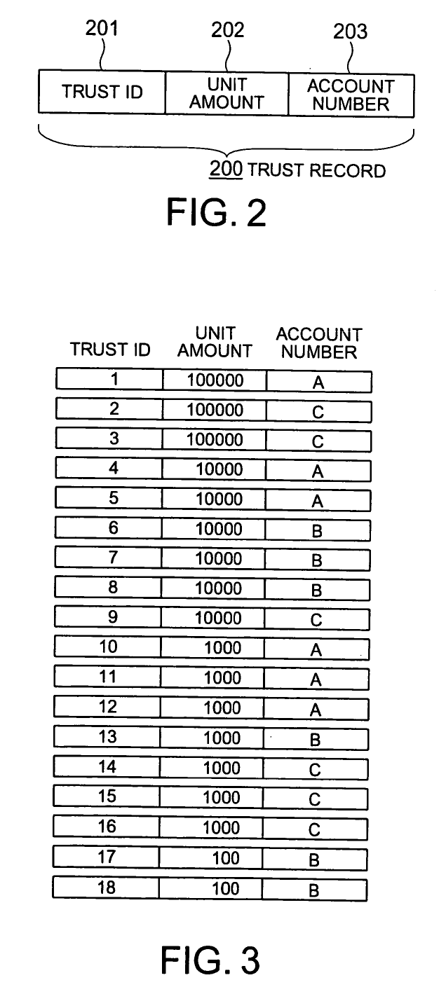

Further, the data structure of the trust record shown in FIG. 2 is only one example, and the data structure of the trust record in the present invention can be freely changed as far as the trust record is a record which shows a unit amount and which is registered by the number corresponding to the balance in each account. Of course, the processing procedure can be changed appropriately according to the data structure of the record.

Incidentally, it is possible to cause data for specifying a depositor of each account such as “depositor name” included in the conventional account record to be included in a record showing a unit amount of this embodiment. In this case, however, data amount of a record showing a unit amount becomes large and there are many cases in which a depositor has plural accounts. Accordingly, in view of data processing efficiency, it is desirable that data for specifying a depositor of each account is managed in a database manner in a form of a depositor record comprising “depositor ID”, “depositor name”, “address”, “telephone number” and the like or a holding account record comprising “depositor ID”, “account number” and the like independently from the record showing a unit amount according to this embodiment.

(Account Managing/Settling System)

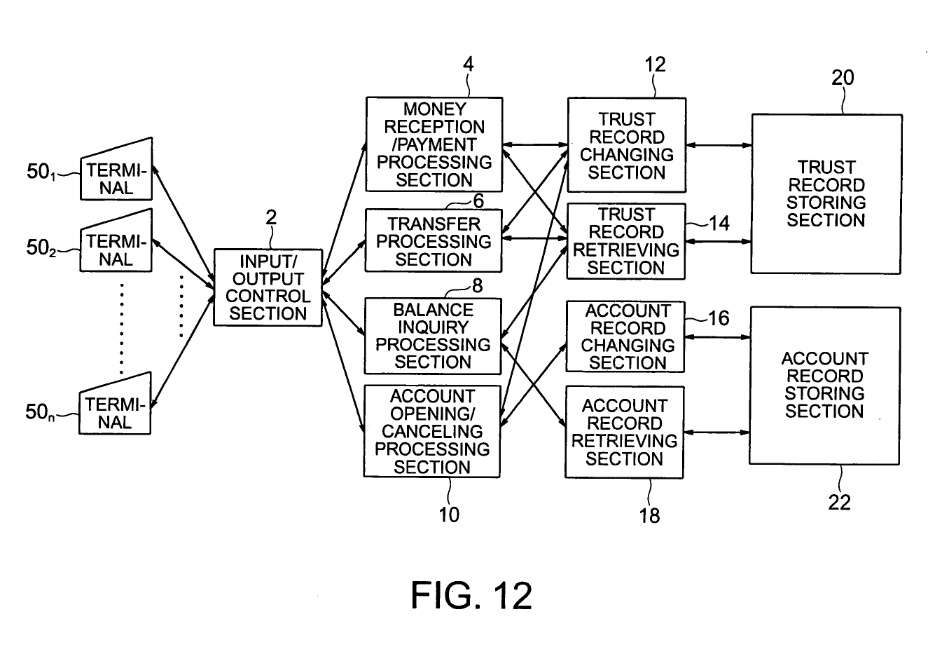

The account managing/settling method of the first embodiment is conducted by an account managing/settling system show in FIG. 12. The account managing/settling system is provided with an input/output control section 2, a money reception/payment processing section 4, a transfer processing section 6, a balance inquiry processing section 8, an account opening/canceling processing section 10, a trust record updating section 12, a trust record retrieving section 14, an account record changing section 16, an account record retrieving section 18, a trust record storing section 20, an account record storing section 22 and a plurality of terminals 50₁ to 50ₙ.

The input/output control section 2 receives each of processing demands generated from the plurality of terminals 50₁ to 50ₙ and judges the content of the demand to feed parameters such as an input account number and the like to one of the money reception/payment processing section 4, the transfer processing section 6, the balance inquiry processing section 8 and the account opening/canceling processing section 10 and request a processing to the section.

The money reception/payment processing section 4 instructs the trust record changing section 12 to add/delete trust records corresponding to a designated amount. The trust record changing section 12 performs adding/deleting processing of the instructed trust records, namely, the instructed unit amount records and an upper/lower exchanging processing accompanied thereby on trust records stored in the trust record storing section 20. When the processing is completed, the trust record changing section 12 notifies to the money reception/payment processing section 4 that the changing of the designated trust records has been completed. On receipt of this, the money reception/payment processing section 4 notifies completion of the money reception/payment processing to the input/output control section 2. The input/output control section 2 notifies the completion of the processing to the terminal which generated the corresponding processing demand.

The transfer processing section 6 notifies a transfer source account number, a transfer destination account number and transfer amount delivered from the input/output control section 2 to the trust record changing section 12 to instruct change of the account number of the trust record. The trust record changing section 12 performs change of the instructed account number and lower/upper exchanging processing required therefor to trust records stored in the trust record storing section 20. When the processing is completed, the trust record changing section 12 notifies completion of the processing to the transfer processing section 6 and the transfer processing section 6 transfers the same to the input/output control section 2.

The input/output control section 2 sends the completion notification to the terminal which generated the corresponding transfer processing demand.

The balance inquiry processing section 8 transfers the account number to the trust record retrieving section 14 and instructs it to perform accumulation of the balance. The trust record retrieving section 14 retrieves the trust records having the designated account number from the trust record storing section 20 to check their trust IDs, sums the unit amounts of the trust records judged to be accumulatable as the balance, and then notifies the balance to the balance inquiry processing section 8. The balance inquiry processing section 8 notifies the balance to the input/output control section 2, and the input/output control section 2 returns the balance to the terminal which has generated the corresponding inquiry demand.

When the account opening/canceling processing section 10 receives an account opening demand from the input/output control section 2, it instructs the account record changing section 16 and the trust record changing section 12 to register the account record and the trust record of the designated account number. The account record changing section 16 and the trust record changing section 12 produce the designated record to register the same to the account record storing section 22 and the trust record storing section 20, respectively, and return a processing completion notification to the account opening/canceling processing section 10. When the account opening/canceling processing section 10 receives these two completion notifications, it notifies completion of the account opening processing to the input/output control section 2. When the input/output control section 2 receives this notification, it transmits the processing completion to the terminal which has generated the corresponding account opening demand. Regarding an account canceling demand, similarly, deletion of records having a designated account number is instructed to the account record changing section 16 and the trust record changing section 12. Transmission of a processing completion notification is conducted in a manner similar to the case of the account opening processing.

As explained above, according to this embodiment, by registering records showing preset unit amounts to each account by the number corresponding to the balance in the account, it is made possible to perform an updating processing and a retrieving processing independently from each other and in parallel to each other, so that even when a system failure occurs during operation in a transfer processing between accounts, an account managing method and an account settling method which can realize a banking system with a high reliability which is prevented from falling in an unfair state such as balance mismatching or the like.

(Second Embodiment)

Next, a lot managing method according to a second embodiment of the present invention will be explained.

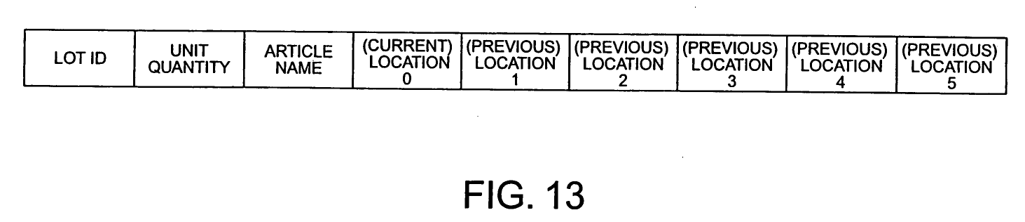

FIG. 13 shows a constitution of a unit lot record used in the second embodiment. As understood from FIG. 13, in the second embodiment, a lot management of a material or parts which can be divided or merged regarding the same item. By using the unit lot record, a record where a material or parts have been subjected to place or location transfer up to five times to reach a current location can be recorded accurately so that information can be provided. Further, even when a system failure occurs during location transfer processing of the material or parts, division of the lot and location transfer thereof can be handled safely and reliably without causing a deficiency of quantity mismatching like the account transfer processing in the first embodiment.

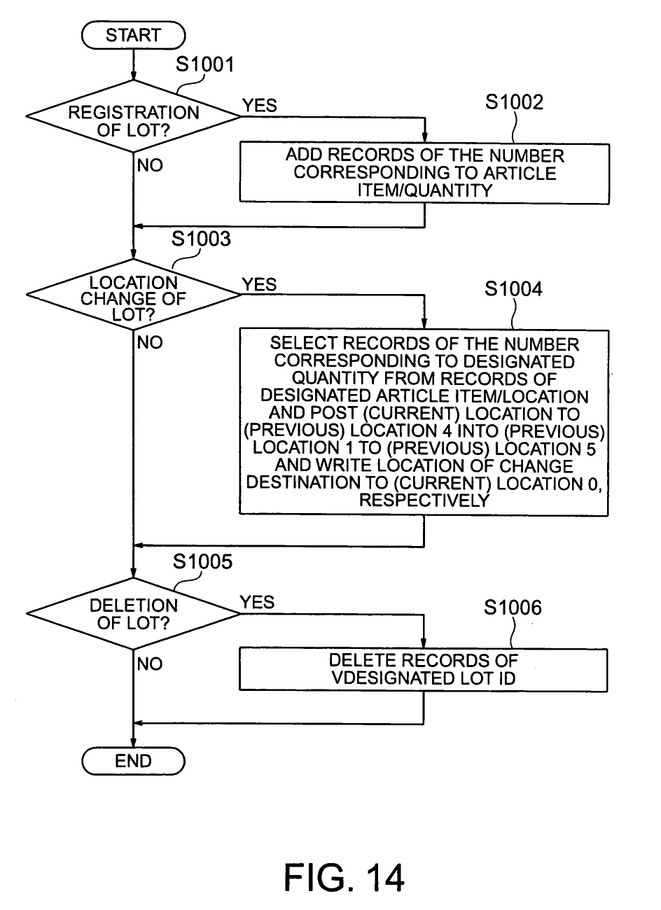

An outline of a processing of the lot managing method according to the embodiment is shown in FIG. 14.

That is, the lot managing method of the embodiment can perform a processing (S1001 and S1002) where, when a new subject to be managed occurs, unit lot records of the number corresponding to an item/quantity thereof are written with a current location to be registered, a processing (S1003 and S1004) where selection of unit lot records to be updated according to change of a location of the subject of the designated item/quantity to be managed and updating of their location field are performed, and a processing (S1005 and S1006) where deletion of unit lot records of designated IDs is performed for removing them from the subject to be managed.

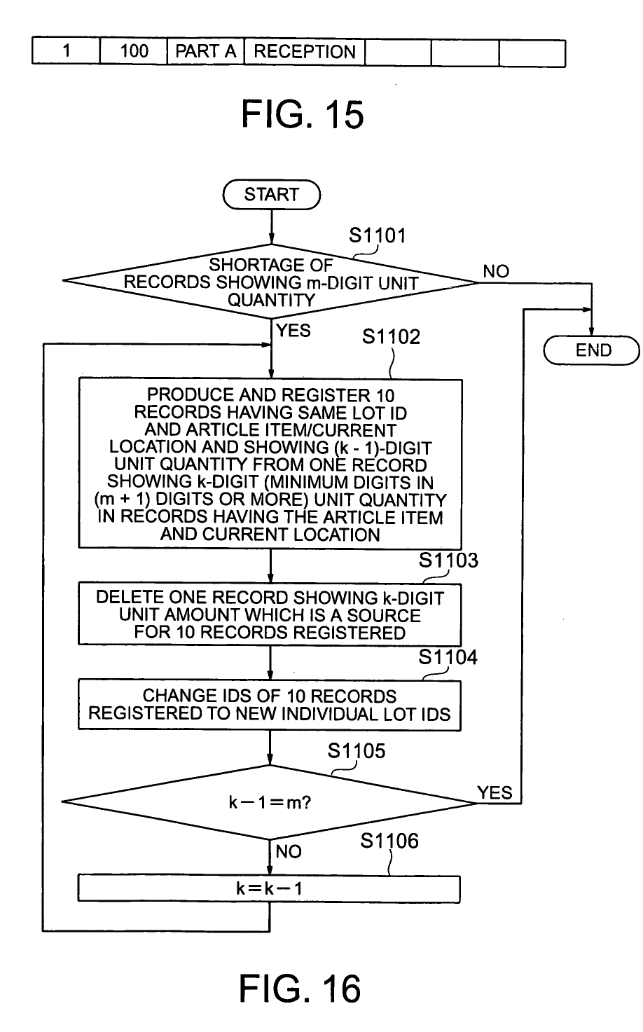

In this embodiment, for example, after one kind of parts (item=“part A”) are received in an assembling factory with a definite number (100 pieces), each state in such a course that the parts are distributed to two assembling lines of “a first line” and “a second line” (60 pieces and 30 pieces), and 20 parts are assembled in each “Product 1#(manufacture number) xxx” and 10 parts are assembled in each “Product 2# (manufacture number) xxx”, respectively and updating during the course can be managed. FIG. 15 shows a state that a unit lot record has been registered in a DB (database) of the embodiment in response to reception of 100 parts A.

Next, a lot division processing shown in FIG. 16 is performed in response to that 60 parts of 100 parts have been moved to the first line. That is, in case that unit lot records are short of m-digit (m is an integer) unit quantity required for the processing (YES in Step S1101), the lot division processing is conducted according to the processing shown in FIG. 16 (S1102 to S1106). The lot division processing is conducted in the following manner.

First, from one unit lot record showing a k-digit unit quantity serving as the minimum-digit unit quantity in at least (m+1)-digit unit quantities of unit lot records having the corresponding item/current location, 10 unit lot records with a (k−1)-digit unit quantity having the same lot ID/item/current location are produced and registered (a lower unit record producing step: S1102). Next, the one unit lot record showing the k-digit unit quantity which is the source for the registered 10 unit lot records showing the (k−1)-digit unit quantity is deleted (a higher unit record deleting step: S1103).

Then, the lot IDs of the registered 10 unit lot records showing the (k−1)-digit unit quantity are changed to new individual lot IDs (an individual ID changing step: S1104). Further, unless the (k−1) digits match with m digits (NO in Step S1105), the Steps S1102 to S1106 are repeated using the previous (k−1) as new k until the (k−1) digits match with the m digits (S1106).

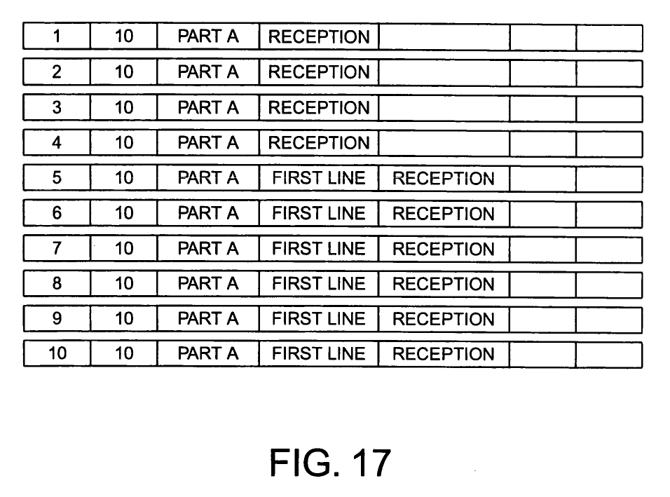

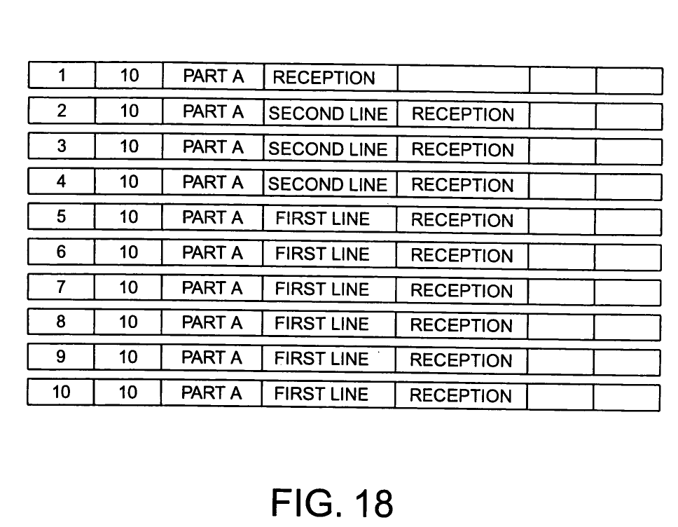

FIG. 17 shows a state where 60 pieces are moved to the first line and 40 pieces are left in the reception according to the above-described lot division. Further, three of four records whose current location is reception and whose unit quantity is 10 are selected in response to transfer of 30 pieces to the second line, and “reception” is written in their previous locations 1 and “second line” is written in their current locations (refer to FIG. 18).

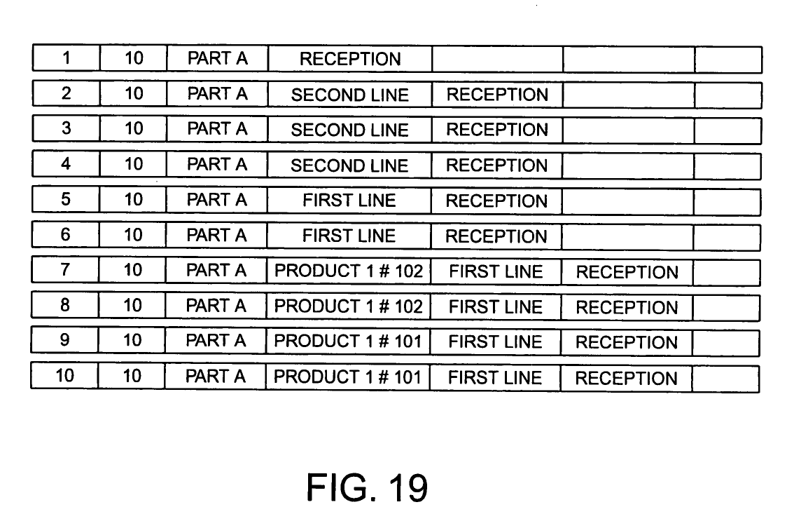

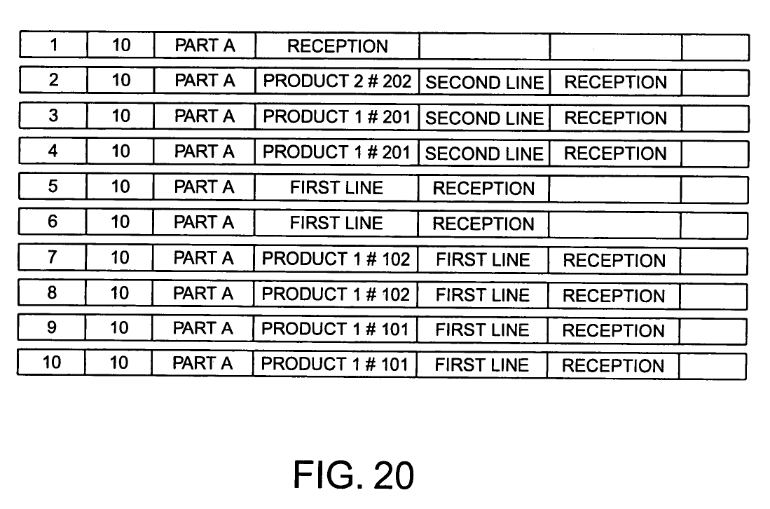

Next, after 20 pieces of these Parts A in the first line are assembled into the Product 1#(manufacture number) 101 and the Product 1# 102 respectively, a location changing processing of the lot is performed to update the records to a state shown in FIG. 19. Similarly, after 20 pieces of the parts A in the second line are assembled into the Product 1#201 and 10 pieces thereof are assembled into the Product 2#202, the location change of the lot is performed to update a state shown in FIG. 20.

Now, in the state shown in FIG. 20, when a record(s) satisfying the conditions of item=part A and current location=first line is retrieved, records with lot ID=5 and lot ID=6 are selected. When the unit quantities of these records are summed, it can be known that the stock of the parts A in the first line is 20 pieces.

Further, when a record(s) satisfying the conditions of current location=product 1#201 and item=part A are retrieved, records with lot ID=3 and lot ID=4 can be obtained, from which it can be known that these records have previous location 1=second line and their previous location 2=reception. Similarly, by retrieving a record(s) satisfying current location=product 1#102 and item=part A to find records with lot ID=7 and lot ID=8 and knowing that these records have previous location 1=first line and previous location 2=reception, it is ascertained that one of parts A included in two products (#201 and #102) of the same kind, which belong to Product 1, has been assembled in the second line and the other has been assembled in the first line.

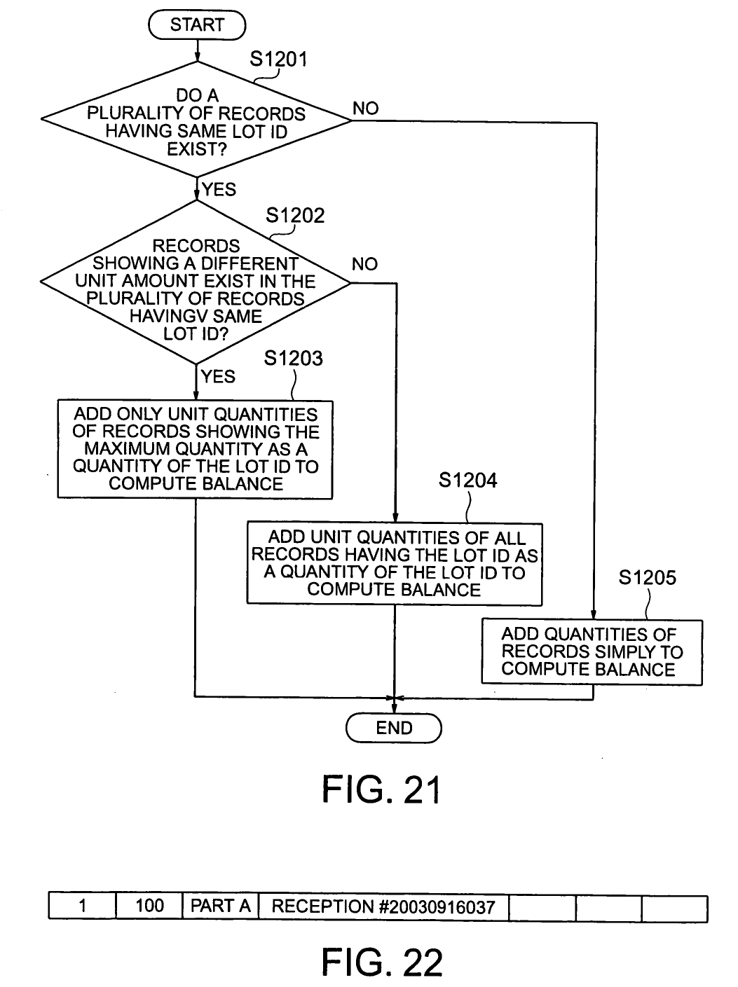

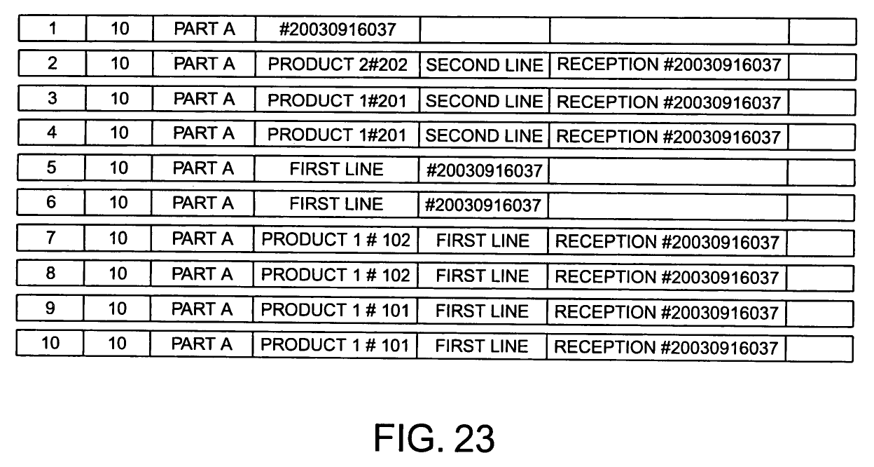

Thus, according to the lot managing method of this embodiment, various inquiries about current location of parts of each unit quantity or its transfer record can be processed efficiently. In these retrieval processings, when a check processing shown in FIG. 21 is additionally applied to the selected record(s), a right retrieval (accumulation) result can be obtained even during the lot division processing shown in FIG. 16 like matching preservation of the account balance in the first embodiment.

Next, the check processing shown in FIG. 21 will be explained. In case that a check processing is conducted, as shown in FIG. 21, judgment is made about whether or not a plurality of unit lot records having the same lot ID exist (S1201), and a check processing corresponding to the judgment result is performed. That is, in case that a plurality of unit lot records having the same lot ID exist (YES in Step S1201), the case is recognized to be in the course of the lot division processing, and judgment is made about whether a unit lot record showing a different unit quantity(ies) exists in the plurality of unit lot records (S1202).

In case that the unit lot record showing a different unit quantity(ies) exists in the plurality of unit lot records having the same lot ID (YES in Step S1202), only the unit quantity of one unit lot record having the maximum quantity thereof is added as the amount of the lot ID to obtain the sum (S1204). On the other hand, in case that all the unit quantities of the plurality of unit lot records having the same lot ID are the same (NO in Step S1202), all the unit quantities of the plurality of unit lot having the same lot ID are added as the quantity of the lot ID (S1204). That is, addition of (the quantity)×(the number of unit lot records) is performed as the quantity of the lot ID. Further, in case that a plurality of unit lot records having the same lot ID do not exist (NO in Step S1201), an ordinary summing computation for adding the quantities of unit lot records simply is conducted (S1205).

As explained above, according to the lot managing method of the embodiment, by registering records of preset unit quantities by the number corresponding to the corresponding item and location record, the quantity of the item and location or the item and location record can be obtained easily. Another feature of the managing method lies in that, when a state is updated, record of a smaller unit quantity are produced by the record dividing processing, as necessary. For this reason, only by registering a small number of records comprising records of a large unit quantity originally and performing a necessary division, an actual smaller division can be expressed by a relatively small number of records. This can considerably reduce the number of records as compared with a case that many records of the minimum unit quantity are used, so that a processing efficiency can be enhanced.

That is, the total number of records is at most (the number of combination of item and record)×(the number of kinds of unit quantity)×(base number of unit quantity−1). The number of combinations of item and record is limited to combinations of item and record regarding lots existing simultaneously in actual. The number of kinds of unit quantity is the maximum unit figures of the size (quantity) of each lot, and the base number of the unit quantity is n in case of n-base notation. These two numbers are predicted or determined in advance. For example, ten digits in decimal notation is 10×(10−1)=10×9=90. However, a case of requiring 90 records is only a case that respective digits of the sum quantity of the same item and the same record all are 9, namely, the case of 9,999,999,999. Therefore, usually, the number of records of the same item and the same record are considerably smaller than the above case.

Further, the number of combinations of item and record is limited in a different field content actually generated by registration or division. Therefore, if aspects of movement or division of lots are known in advance, namely if an actual handling procedure of lots is defined, combinations to be generated can be predicted in advance so that the maximum number of records to be generated can be estimated. Thereby, such an advantage can be achieved that waste of storing capacity due to storage setting exceeding a required storing capacity is prevented.

In case that lot division has been conducted in the conventional method, it is a common procedure to clarify a correspondence with the lot number before division by such a method that a lot number after division is obtained by attaching a branch number to the lot number before division. This is because a lot is not retrieved and managed with the combination of item and location/possession record but it is necessary to perform retrieval and management according to the lot number. Therefore, for attaching a lot number, it is necessary to predefine a numbering system considering division/retrieval procedure of a lot.

The lot ID in this embodiment is applied for only managing a uniqueness of a unit lot record regardless of such a lot dividing/managing procedure. Therefore, when a lot ID is added (created), any method for issuing an ID different from existing IDs can be adopted, and it is unnecessary to consider the dividing/managing procedure of a lot. In this embodiment, since a function equivalent to a systematic lot retrieval/management based upon the lot number conventionally used can be achieved by retrieval of a unit lot record based upon the combination of item and history, the function for issuing a lot number systematically considering division/movement of a lot preliminarily is not required. By causing a portion of a record to include ID for identifying a lot, retrieval of a lot derived (divided) therefrom can be performed. For example, when not only a step name but also ID of a received lot are recorded in the “reception” in the above history, retrieval/accumulation of a divided lot(s) generated thereafter can be performed as a unit lot record including such a division in the record. In FIG. 15, when an inherent ID is applied in the “reception” by adding lot number 20030916037 including 100 parts, such a state as shown in FIG. 22 can be obtained.

When the state shown in FIG. 20 is reached as a result of various divisions, the inherent IDs are included in the histories of respective unit lot records obtained by division.

When a unit lot record is retrieved by designating the record including the inherent ID, a unit lot record of a lot derived (divided) from the lot is separated and identified from other unit lot records having the same item and the same location/possession record for the reception step.

As described above, according to the lot managing method of this embodiment, it is unnecessary to prepare a systematic lot number applying procedure in advance and lots before and after division can be retrieved efficiently by the inherent ID applied at an arbitrary step and the rest of the history.

As shown with the above check procedure in the quantity accumulation as the retrieval result, even while the unit lot record changing section is performing a lot dividing processing according to the procedure shown in FIG. 16, the unit lot record retrieval can accumulate a right quantity by checking IDs of the respective unit lot records according to the procedure shown in FIG. 21. Accordingly, the unit lot record retrieval section can always perform retrieval and accumulation of the quantity of a designated lot regardless of whether or not the unit lot record changing section is changing the unit lot records. That is, the lot retrieving processing can be performed completely in parallel with the lot updating processing. Further, even in case that a failure has occurred in the system during a dividing processing and the processing has not been completed, a feature can be achieved that such a situation that the quantity of the lot wrongly increases/decreases does not occur.

(Lot Managing System)

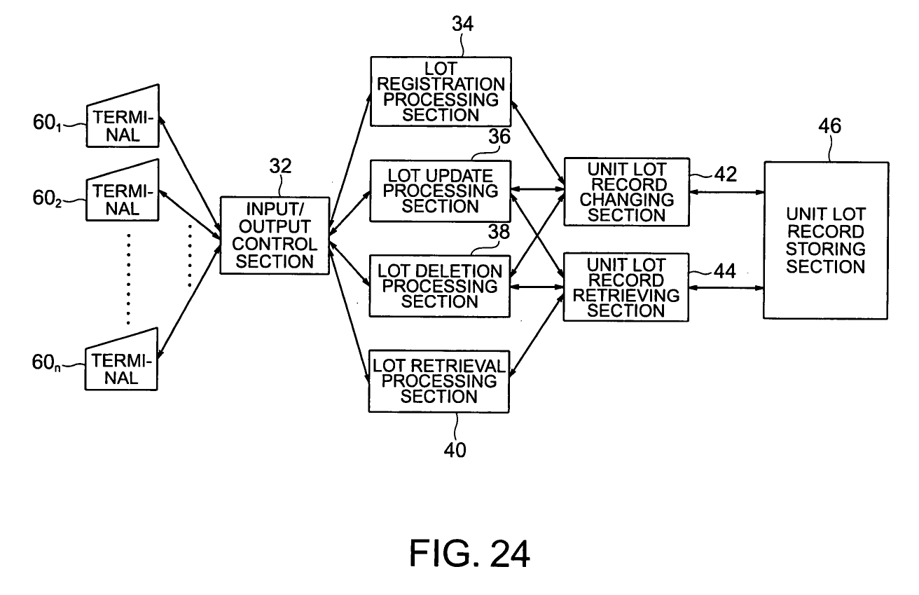

The lot managing method of the above-described second embodiment is performed by a lot managing system shown in FIG. 24. The lot managing system is provided with an input/output control section 32, a lot registration processing section 34, a lot update processing section 36, a lot deletion processing section 38, a lot retrieval processing section 40, a unit lot record changing section 42, a unit lot record retrieving section 44, a unit lot record storing section 46 and a plurality of terminals 60₁ to 60ₙ.

The input/output control section 32 receives each of processing demands generated from the plurality of terminals 60₁ to 60ₙ to judge its content and transmits inputted parameters such as article name, history and the like to either one of the lot registration processing section 34, the lot update processing section 36, the lot deletion processing section 38 and the lot retrieval processing section 40 to leave a processing of the demand to the one.

The lot registration processing section 34 has a designated article name and an initial history and instructs the unit lot record changing section 42 to add unit lot records of kinds and quantity corresponding to designated quantity. The unit lot record changing section 42 conducts the instructed addition of unit lot records to the unit lot record storing section 46. When the addition has been completed, the unit lot record changing section 42 notifies the lot registration processing section 34 of the completion and the lot registration processing section 34 transmits the input/output control section 32 of the completion of the lot registration processing. The input/output control section 32 notifies the terminal which has generated the corresponding lot registration processing demand of the completion of the processing.

The lot update processing section 36 instructs the unit lot record retrieving section 44 to retrieve unit lot records of designated article name and history. Thereby, the unit lot record retrieving section 44 retrieves coincident unit lot records from the unit lot records in the unit lot record storing section 46 and return them back to the lot update processing section 36. The lot update processing section 36 instructs the unit lot record changing section 42 to change the histories of the designated quantity of unit lot records from the retrieved unit lot records. The unit lot record changing section 42 performs a record division processing, as needed, and change the histories of unit lot records corresponding to the designated quantity to notify the lot update processing section 36 of the completion of the lot registration processing. The lot update processing section 36 transmits to the input/output control section 32 the completion of the lot update processing and the input/output control section 32 notifies the terminal which has generated the corresponding lot update processing demand of the completion of the processing.

The lot deletion processing section 38 instructs the unit lot retrieving section 44 to retrieve unit lot records of a designated article name and history. Thereby, the unit lot record retrieving section 44 retrieves coincident unit lot records from the unit lot records in the unit lot record storing section 46 to return them back to the lot deletion processing section 38. Next, the lot deletion processing section 38 instructs the unit lot record changing section 42 to delete these unit lot records. The unit lot record changing section 42 deletes the instructed unit lot records from the unit lot record storing section 46 and notifies the lot deletion processing section 38 of the deletion completion. The lot deletion processing section 38 transmits the lot deletion processing completion to the input/output control section 32, and the input/output control section 32 notifies the terminal which has generated the corresponding lot deletion processing demand of the completion of processing.

The lot retrieval processing section 40 instructs the unit lot record retrieving section 44 to retrieve unit lot records of a designated article name and history. Thereby, the unit lot record retrieving section 44 retrieves coincident unit lot records from the unit lot records in the unit lot record storing section 46 to accumulate the quantity of the retrieved unit lot records and return it back to the lot retrieval processing section 40. The lot retrieval processing section 40 returns the data to the input/output control section 32 as the quantity of the designated lot. The input/output control section 32 returns the quantity to the corresponding terminal which generated the corresponding lot retrieval demand.

As explained above, according to this embodiment, it is made possible to perform an update processing and a retrieval processing independently from each other and in parallel to each other, so that even when a system failure occurs during operation, a lot managing method and a lot managing system with a high reliability which is prevented from falling in an unfair state such as quantity mismatching can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A method of managing an account utilizing a computer comprising:
registering records of preset unit amount to each account by the number corresponding to the balance in the account.

2. The method according to claim 1, wherein the registering step comprising:
registering the balance in the account to each account in a first memory region; and
registering records of unit amount by the number corresponding to the balance in the account in a second memory region.

3. The method according to claim 1, wherein the unit amount includes, as a unit amount of each digit expressed by n-base notation (n is a natural number of at least 2), an amount whose unit is defined as the minimum number of the digit where the header numeral is “1” and each numeral subsequent thereto is “0”.

4. The method according to claim 3, comprising a lower exchanging step of, when a designated number of records showing designated m-digit (“m” is an integer) unit amount do not exist, in the records showing the unit amounts of respective digits expressed by the n-base notation registered in a designated account, producing, from one record showing a k-digit unit amount which is a minimum-digit unit amount in (m+1)- or more-digit unit amounts, records showing a (k−1)-digit unit amount such that the sum amount thereof is coincident with the k-digit unit amount to register the same in the corresponding account.

5. The method according to claim 4, wherein the record of the unit amount includes ID for identifying each record, a unit amount and an account number for identifying the account, and the lower exchanging step comprising
a lower unit record producing step of, from one record showing the k-digit unit amount, producing and registering at most n records showing (k−1)-digit unit amount having the same ID and the same account number;
a higher unit record deleting step of deleting the one record showing the k-digit unit amount; and
an individual ID changing step of changing IDs of the at most n records showing the registered (k−1)-digit unit amount to new individual Ids.

6. The method according to claim 4, wherein the lower exchanging step repeats the lower unit record producing step, the higher unit record deleting step and the individual ID changing step using the previous (k−1) as new k until the (k−1) digit coincide with the designated m digit.

7. The method according to claim 3, comprising an upper exchanging step of, when records showing a j-digit (“j” is an integer) unit amount, a sum amount of which is equal to a (j+1)-digit unit amount, exist in records showing unit amounts of respective digits expressed by the n-base notation registered in the designated account, producing one record showing (j+1)-digit unit amount from the records to register the same in the corresponding account.

8. The method according to claim 7, wherein the record of the unit amount includes ID for identifying each record, a unit amount and an account number for identifying the account, and
the upper exchanging step comprises
a same ID changing step of changing all IDs of the records showing the j-digit unit amount, whose sum amount is equal to the (j+1)-digit unit amount, to the same ID,
a higher unit record producing step of producing and registering one record showing a (j+1)-digit, which has the same ID and the same account number as those of records having the j-digit unit amount, whose sum amount is equal to the (j+1)-digit unit amount, and
a lower unit record deleting step of deleting the records showing the j-digit unit amount, whose sum amount is equal to the (j+1)-digit unit amount.

9. The method according to claim 8, wherein, when the records whose sum amount is equal to a (j+2)-digit unit amount exist as records showing the (j+1)-digit unit amount, the upper exchanging step repeats the same ID changing step, the higher unit record producing step and the lower unit record deleting step using a previous (j+1) as new j.

10. A method of performing settling between amounts utilizing a computer comprising:
registering records showing preset unit amounts to each account by the number corresponding to the balance in the account;
retrieving, from records showing unit amounts registered in an account of a transfer source, records of the number corresponding to an amount to be settled when settlement between accounts is required; and
changing all the retrieved records to records in an account of a transfer destination.

11. A computer-readable medium containing an account managing program for managing an account utilizing a computer, the program comprising instructions for:
registering records showing preset unit amounts to each account by the number corresponding to the balance in the account.

12. A computer-readable medium containing an account settling program for settling an account utilizing a computer, the program comprising instructions for:
registering records showing preset unit amounts to each account by the number corresponding to the balance in the account and
retrieving, from records showing unit amounts registered in an account of a transfer source, records of the number corresponding to an amount to be settled when settlement between accounts is required and changing all the retrieved records to records in an account of a transfer destination.

13. A lot managing method for managing the locations/possessions of articles in a dividable lot utilizing a computer comprising,
registering a preset unit quantity of records by the number corresponding to the generated quantity when the articles are generated as a subject to be managed in one location/possession.

14. The lot managing method according to claim 13, wherein the unit quantity includes, as a unit quantity of each digit expressed by n-base notation (n is a natural number of at least 2), a quantity whose unit is defined as the minimum number of the digit where a header numeral is “1” and each numeral subsequent thereto is “0”.

15. The lot managing method according to claim 14, comprising
a record dividing step of, when records having the same location/possession and showing a m-digit quantity to be changed do not exist in records showing unit quantities of respective digits expressed by the n-base notation, some of which are to be changed regarding locations/possessions thereof, registering records showing a (k−1)-digit unit quantity by such a number that a sum account thereof becomes equal to the k-digit unit quantity instead of one record showing the k-digit unit quantity which is a minimum-digit unit amount in (m+1)- or more-digit unit amounts.

16. The lot managing method according to claim 15, wherein
the unit quantity record includes an ID for identifying each record, a unit quantity and a location/possession history; and the record dividing step includes a lower unit record producing step of producing and registering records having the same ID and the same location/possession history and showing a (k−1)-digit unit amount from one record showing the k-digit unit amount such that a sum quantity thereof becomes equal to the k-digit unit quantity,
a higher unit record deleting step of deleting the one record showing the k-digit unit quantity, and
an individual ID changing step of changing IDs of the records having the same ID and showing the registered (k−1)-digit unit quantity to new individual IDs.

17. The lot managing method according to claim 15, wherein the record dividing step repeats the lower unit record producing step, the higher unit record deleting step and the individual ID changing step using a previous (k−1) as new k until the (k−1) digit are coincident with the m digit to be changed.

18. An account managing/settling system comprising an input/output control section, a money reception/payment processing section, a transfer processing section, a balance inquiry processing section, an account opening/canceling processing section, a trust record changing section, a trust record retrieving section, an account record changing section, an account record retrieving section, a trust record storing section, an account record storing section and a plurality of terminals, wherein
the input/output control section receives each of processing demands from the plurality of terminals to judge contents thereof, and transmit data attendant to the processing demand to either one of the money reception/payment processing section, the transfer processing section, the balance inquiry processing section, and the account opening/canceling processing section to request a processing;
the money reception/payment processing section instructs the trust record changing section to perform addition/deletion of trust records corresponding to the instructed amount from the input/output control section, the trust record changing section performs a processing for the instructed addition/deletion of trust records and an upper/lower exchanging processing accompanied by the same to the trust record stored in the trust record storing section and, when the processing is completed, notifies the money reception/payment processing section that the instructed change of the trust records has been completed, and the money reception/payment processing section notifies the input/output control section of the completion of the money reception/payment processing on the basis of the notification of the completion of the instructed trust record change, and the input/output control section notifies the completion of the processing to the terminal which generated the corresponding processing demand;
the transfer processing section transmits a transfer source account number, a transfer destination account number and a transfer amount sent from the input/output control section to the trust record changing section to instruct the trust record changing section to perform changing of the account numbers of the trust records, the trust record changing section performs the instructed changing processing of the account numbers and a necessary lower/upper exchanging processing to the trust records stored in the trust record storing section and, when the processing is completed, notifies a completion of the processing to the transfer processing section, the transfer processing section transmits a completion notification of the processing to the input/output control section, and the input/output control section transmits the completion notification to the terminal which generated the transfer processing demand;
the balance inquiry processing section transmits the account number to the trust record retrieving section to instruct the trust record retrieving section to perform accumulation of the balance in the account, the trust record retrieving section retrieves trust records having the instructed account number from the trust record storing section to check trust IDs of the trust records having the instructed account number and sum unit amounts of the trust records which have been determined to be accumulable as the balance and notifies the balance to the balance inquiry processing section, the balance inquiry processing section transmits the balance to the input/output control section, and the input/output control section returns the balance to the terminal which generated the inquiry demand;
on receipt of an account opening demand from the input/output control section, the account opening/canceling processing section instructs the account record changing section and the trust record changing section to perform registration of account records and trust records of a designated account number, the account record changing section and the trust record changing section produce the instructed records to register the records in the account record storing section and the trust record storing section, respectively, the account record storing section and the trust record storing section return processing completion notifications back to the account opening/canceling processing section, the account opening/canceling processing section notifies completion of the account opening processing to the input/output control section on receipt of both the completion notifications, the input/output control section receives the completion notification of the account opening processing to transmits a processing completion to the terminal which generated the opening demand; and
on receipt of an account canceling demand from the input/output control section, the account opening/canceling processing section instructs the account record changing section and the trust record changing section to perform deletion of the account records and the trust records having the designated account number, the account record changing section and the trust record changing section delete the designated records from the account record storing section and the trust record storing section, respectively, the account record storing section and the trust record storing section return processing completion notifications to the account opening/canceling processing section, the account opening/canceling processing section notifies completion of the account canceling processing to the input/output control section upon receipt of both the processing completion notifications, and the input/output control section transmits a processing completion to the terminal which generated the canceling demand upon receipt of the notification of the completion of the account canceling processing.

19. A lot managing system comprising an input/output control section, a lot registration processing section, a lot update processing section, a lot deletion processing section, a lot retrieval processing section, a unit lot record changing section, a unit lot record retrieving section, a unit lot record storing section, and a plurality of terminals, wherein
the input/output control section receives each of processing requests generated from the plurality of terminals to judge contents thereof and transmit data attendant to the processing demand to either one of the lot registration processing section, the lot update processing section and the lot retrieval processing section to request a processing;
the lot registration processing section has a designated article name and initial history and instructs the unit lot record changing section to perform addition of unit lot records of kinds and quantity corresponding to a designated quantity, the unit lot record changing section performs the instructed addition of the unit lot records to the unit lot record storing section, upon completion of the addition, the unit lot record changing section notifies the completion to the lot registration processing section, the lot registration processing section transmits the completion of the lot registration processing to input/output control section, and the input/output control section notifies the completion of the processing to the terminal which generated the lot registration processing demand;
the lot update processing section instructs the unit lot record retrieving section to perform retrieval of unit lot records having a designated article name/history, the unit lot retrieving section retrieves coincident unit lot records from the unit lot records in the unit lot record storing section to return the same back to the lot update processing section, the lot update processing section instructs the unit lot record changing section so as to change histories of unit lot records of the designated quantity from the retrieved unit lot records, the unit lot record changing section performs a record division processing, as needed, and change histories of unit lot records corresponding to the designated quantity to notify completion of a history changing processing to the lot update processing section, the lot update processing section transmits completion of the lot update processing to the input/output control section, and the input/output control section notifies completion of the processing to the terminal which generated the lot update processing demand;
the lot deletion processing section instructs the unit lot retrieving section to perform retrieval of unit lot records having a designated article name/history, the unit lot record retrieving section retrieves coincident unit lot records from the unit lot records in the unit lot record storing section to return the same back to the lot deletion processing section, the lot deletion processing section instructs the unit lot record changing section to perform deletion of the retrieved unit lot records, the unit lot record changing section deletes the instructed unit lot records from the unit lot record storing section to notify deletion completion to the lot deletion processing section, the lot deletion processing section transmits a lot deletion processing completion to the input/output control section, the input/output control section notifies the completion of the processing to the terminal which generated the lot deletion processing demand; and
the lot retrieval processing section instructs the unit lot record retrieving section to perform retrieval of unit lot records having a designated article name/history, the unit lot record retrieving section retrieves coincident lot records from the unit lot record storing section to accumulate unit quantities of retrieved unit lot records and return the same back to the lot retrieval processing section, the lot retrieval processing section returns the accumulation result of the unit quantities back to the input/output control section as the quantity of the designated lot, and the input/output returns the accumulation result to the terminal which generated the lot retrieval demand.
